(19) United States
(12) Patent Application Publication
(10) Pub. No.: US 2018/0089157 A1
(43) Pub. Date: Mar. 29, 2018

(54) TEXT EDITING IN AN IMAGE OF A DOCUMENT

(71) Applicant: ABBYY DEVELOPMENT LLC, MOSCOW (RU)

(72) Inventors: ANTON ANDREEVICH MASALOVITCH, MOSCOW (RU); NATALIA ALEXANDROVNA KOLODKINA, MOSCOW (RU); ALEXANDER OLEGOVICH TITOV, MOSCOW (RU)

(21) Appl. No.: 15/282,446

(22) Filed: Sep. 30, 2016

(30) Foreign Application Priority Data
Sep. 28, 2016 (RU) 2016138411

(51) Int. Cl. G06F 17/24; G06K 9/00

(52) U.S. Cl. CPC G06F 17/24; G06K 2209/01; G06K 9/00442

(57) ABSTRACT

Provided are methods and computer systems for text editing in an electronic document.

### CROSS REFERENCE TO RELATED APPLICATIONS

The present application claims the benefit of priority under 35 USC 119 to Russian Patent Application No. 2016138411, filed Sep. 28, 2016; disclosure of which is herein incorporated by reference in its entirety for all purposes.

### FIELD

The present disclosure relates generally to computer systems and more specifically to systems and methods for text editing an electronic document.

### SUMMARY

One embodiment is a text editing method comprising: receiving a selected pixel area of an original electronic document comprising an original background portion; displaying to a user an editable area, which corresponds to the selected area, without modifying the background portion; receiving a feedback from the user regarding a textual modification to be made in the editable area and executing the modification to produce a modified editable text, so that the editable area with the modified editable text becomes a modified editable area, wherein the background portion remains unmodified; rasterizing the modified editable area to produce a rasterized modified area comprising a) a modified text portion and b) a background portion, which is unmodified compared to the background portion of the selected pixel area; and inserting the rasterized modified area into the electronic document to produce a modified electronic document.

Another embodiment is a computer system comprising: a memory; and a processor operatively coupled to the memory, the processor is configured to: receive a selected pixel area of an original electronic document comprising an original background portion; display to a user an editable area, which corresponds to the selected area, without modifying the background portion; receive a feedback from the user regarding a textual modification to be made in the editable area and execute the modification to produce a modified editable text, so that the editable area with the modified editable text becomes a modified editable area, wherein the background portion remains unmodified; rasterize the modified editable area to produce a rasterized modified area comprising a) a modified text portion and b) a background portion, which is unmodified compared to the background portion of the selected pixel area; and insert the rasterized modified area into the electronic document to produce a modified electronic document.

Yet another embodiment is a non-transitory computer readable storage medium comprising instructions that, when executed by a processor, cause the processor to perform operations comprising: receiving a selected pixel area of an original electronic document comprising an original background portion; displaying to a user an editable area, which corresponds to the selected area, without modifying the background portion; receiving a feedback from the user regarding a textual modification to be made in the editable area and executing the modification to produce a modified editable text, so that the editable area with the modified editable text becomes a modified editable area, wherein the background portion remains unmodified; rasterizing the modified editable area to produce a rasterized modified area comprising a) a modified text portion and b) a background portion, which is unmodified compared to the background portion of the selected pixel area; and inserting the rasterized modified area into the electronic document to produce a modified electronic document.

### FIGURES

FIG. 1 is a block diagram of an embodiment of a computer device, which may be used for implementing the disclosed methods.

FIG. 2 schematically illustrates one non-limiting embodiment of the disclosed method.

FIG. 3A presents an electronic document in consecutive stages of editing. Although these figure shows for illustrative purposes that the part of a document is displayed to a user, it may be possible to display an entire document so that the user could see an area selected for editing, which on various stages of editing may be referred as a selected pixel area, an editable area, a modified editable area or a rasterized modified area. For example, it may be possible to display to the user only the selected area without displaying other parts of the document.

FIG. 3B presents an electronic document in consecutive stages of editing. Although these figure shows for illustrative purposes that the part of a document is displayed to a user, it may be possible to display an entire document so that the user could see an area selected for editing, which on various stages of editing may be referred as a selected pixel area, an editable area, a modified editable area or a rasterized modified area. For example, it may be possible to display to the user only the selected area without displaying other parts of the document.

FIG. 3C presents an electronic document in consecutive stages of editing. Although these figure shows for illustrative purposes that the part of a document is displayed to a user, it may be possible to display an entire document so that the user could see an area selected for editing, which on various stages of editing may be referred as a selected pixel area, an editable area, a modified editable area or a rasterized modified area. For example, it may be possible to display to the user only the selected area without displaying other parts of the document.

FIG. 3D presents an electronic document in consecutive stages of editing. Although these figure shows for illustrative purposes that the part of a document is displayed to a user, it may be possible to display an entire document so that the user could see an area selected for editing, which on various stages of editing may be referred as a selected pixel area, an editable area, a modified editable area or a rasterized modified area. For example, it may be possible to display to the user only the selected area without displaying other parts of the document.

FIG. 4A schematically illustrates reinserting a rasterized modified area (edited area) in the original electronic document.

FIG. 4B schematically illustrates reinserting a rasterized modified area (edited area) in the original electronic document.

FIG. 4C schematically illustrates reinserting a rasterized modified area (edited area) in the original electronic document.

FIG. 4D schematically illustrates reinserting a rasterized modified area (edited area) in the original electronic document.

FIG. 5 is a more detailed diagram of an illustrative example of a computer system, which may be used for implementing the disclosed methods.

FIG. 6 shows an area of an electronic document, which includes a text portion 620 and a background portion 630.

### DETAILED DESCRIPTION

Unless otherwise specified ‘a’ or ‘an’ means one or more.

Disclosed are methods and systems for editing a textual information in an electronic document.

U.S. patent application publication no. 2016/0217117, which is incorporated herein by reference in its entirety, may be useful for understanding the present disclosure.

“Electronic document” may refer to a file comprising one or more digital content items that may be visually rendered to provide a visual representation of the electronic document (e.g., on a display or a printed material). An electronic document may be produced, for example, by scanning or otherwise acquiring an image of a physical document, such as a paper document, and/or performing optical character recognition to produce the text layer associated with the document. In various illustrative examples, electronic documents may conform to certain file formats, such as PDF, ODT, PDF/A, DjVu, EPub, JPEG, JPEG 2000, JBIG2, BMP, etc. An electronic document may be in a raster image format, which presents an image as a pixel array, such as JPEG, JPEG 2000, TIFF etc., or in a compound format, such as PDF and DjVu. which may contain raster image(s) alone or with vector image(s). The electronic document may include a number of pixels.

“Computing device” may refer to a data processing device having a general purpose processor, a memory, and at least one communication interface. Examples of a computing device that may be employed for the disclosed methods, include, without limitations, a desktop computer, a notebook computer, a tablet computer, and a smart phone.

“Coupled” may refer to being electrically connected and/or communicatively coupled via one or more interface devices, adapters and the like.

“Text” herein may refer to a single symbol or a string of symbols. Examples of text can include letters, characters, or digits, which may be in one or more languages.

“Text layer” may refer to a set of encoded text symbols. One commonly used encoding standard for text symbols is the Unicode standard. The Unicode standard commonly uses 8-bit bytes for encoding American Standard Code for Information Exchange (“ASCII”) characters and 16-bit words for encoding symbols and characters of many languages. Other encoding standards may be used. Text layer may preliminary exist within the electronic document. Or text layer may be produced by performing an Optical Character Recognition (OCR).

“Text portion” may refer to an area of the electronic document (in other words, set of pixels of the electronic document or image) belonging to text symbols represented within the image of the document.

“Information” may refer to a collection of pixels within a target area. Pixels may be different in color from other its contiguous pixels within the target area. Information may include an object (e.g. text, pictures, etc). Information may include pixels that do not correspond to a text portion. Information may contain only a background portion or may include a text portion with a background portion.

“Deletion of information” may refer to a change made to the color of pixels of information within the target area, for example, a text portion of the target area.

“Background pixel” may refer to a pixel that does not represent the text portion.

Electronic documents are used in many spheres of life.

Sometimes it may become necessary to edit a text portion of an electronic document directly in an image of the document. For example, it may become necessary to correct a typographical error in a text portion of an electronic document.

Disclosed methods may allow modifying/editing a text portion of an electronic document directly on an image of the document.

Modifying/editing of a text portion of an electronic document may be performed in a selected pixel area of an electronic document. In some embodiments, the selected pixel area may be a user selected area, i.e. an area of the electronic document, which is selected by receiving a feedback from the user for modifying/editing its text portion after the document has been opened. Yet in some embodiments, the selected pixel area may be a default selected pixel area, i.e. an area of the electronic document, which is selected for modifying/editing its text portion by default, without receiving a feedback after the document has been opened. For example, the default selected area may be, for example, a particular line or lines of the document, e.g. a first line, a second line, a last line, etc., a particular part of the document, e.g. a particular paragraph or a particular page. In some embodiments, the same selected area may be applied to multiple, i.e. two or more documents.

The selected area may contain at least a background portion. In some embodiments, the selected area may contain no initial text portion, which may mean that the selected area does not include any character, such as a letter or a digit. In such a case, modifying/editing a text portion may mean adding a text, which contains at least one character, to the selected area. In this scenario, a step of erasing of a text portion of the selected area may not be necessary.

In some embodiments, the selected pixel area may contain a background portion and a text portion. The text portion of the selected area may contain at least one character, such as a letter or a digit or at least two characters, or at least five characters or at least tex characters or at least twenty characters. The text portion of the selected area may include one or more character sequences, such as a word. The text portion of the selected area may include more than one character sequences. The selected area may include a line or more than one lines; a sentence or more than one sentences; a paragraph or more than one paragraphs; a page or more than one page. In some embodiments, the selected area may be only a part of an electronic document. Yet in some embodiments, the selected pixel area may be a whole electronic document.

The user may select a user selected pixel area, for example, by highlighting the selected area.

From the computer system prospective, selecting the user selected area may mean receiving, via a graphical user interface (GUI), an information regarding the initial user selected pixel area of the electronic document.

Various aspects of the above referenced methods and systems are described in details herein below by way of examples, rather than by way of limitation.

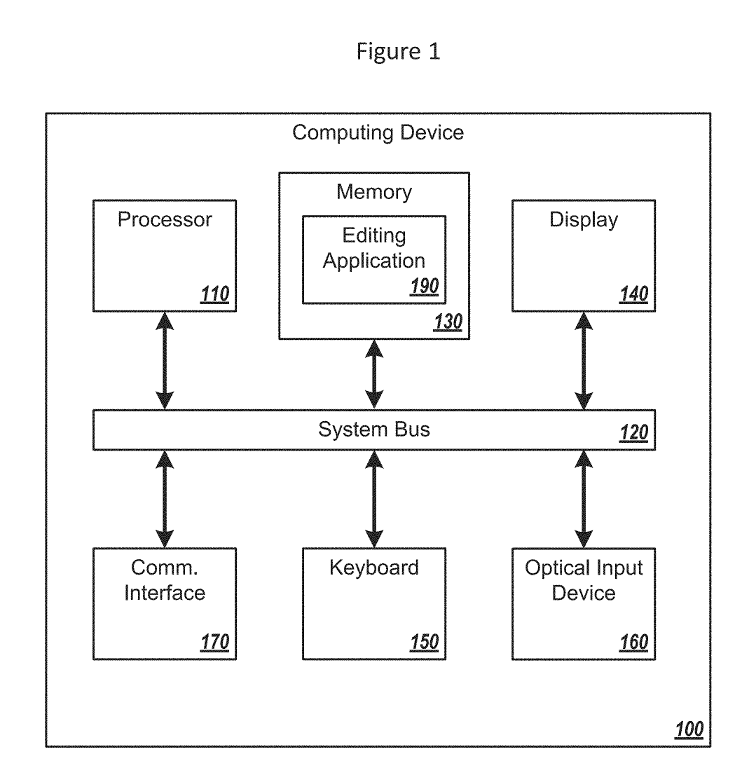

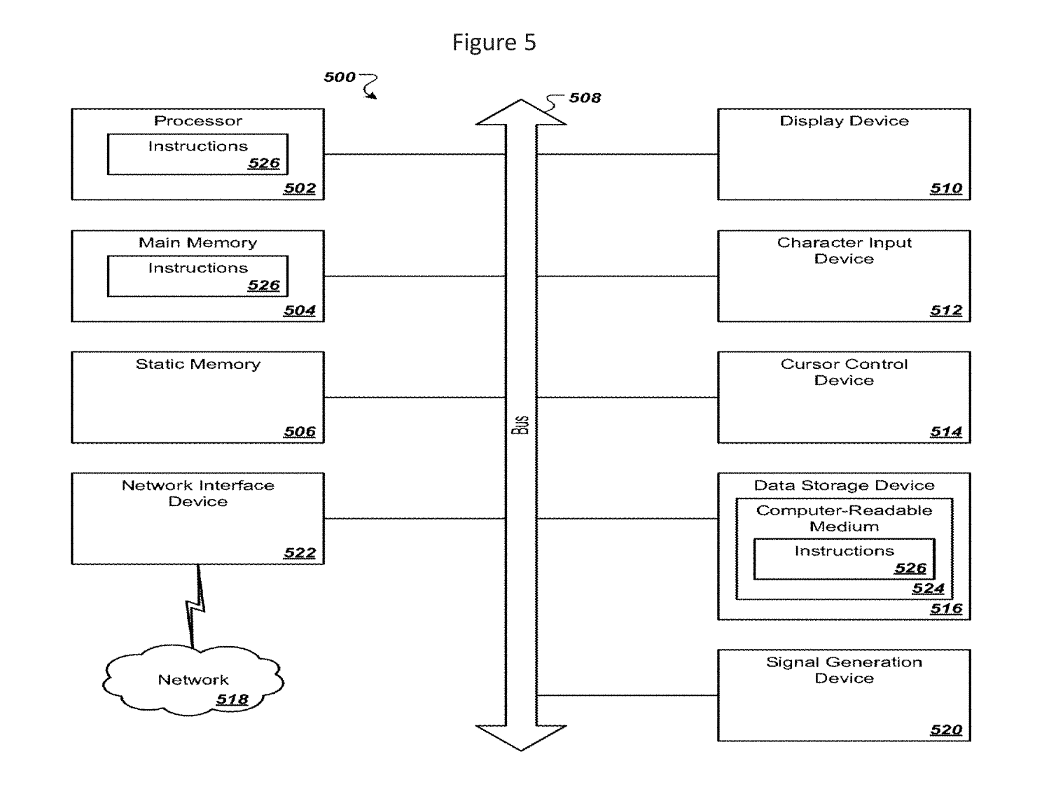

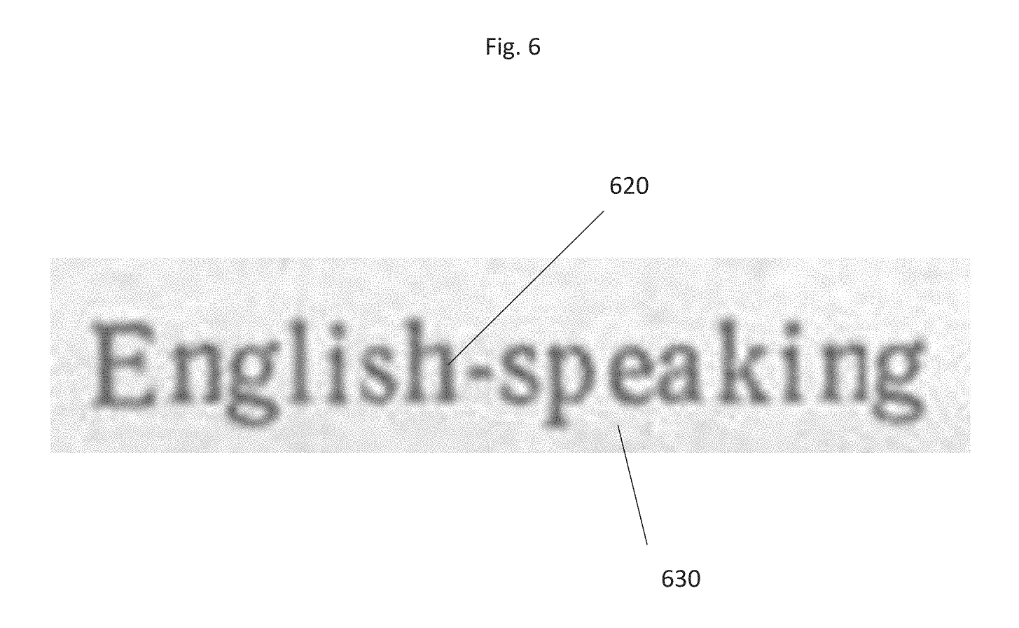

FIG. 1 depicts a block diagram of one illustrative example of computing device 100 which may be used for implementing disclosed method(s). Computing device 100 may be, for example, a tablet computer, a smart phone, a notebook computer, or a desktop computer. An exemplary computing device, which may be used for implementing the disclosed method(s) is discussed in more detail below with reference to FIG. 5.

Computing device 100 may include processor 110 coupled to system bus 120. Other devices coupled to system bus 120 may include one or more of memory 130, display 140, keyboard 150, optical input device 160, a touch screen (not shown), and one or more communication interfaces 170.

In various illustrative examples, processor 110 may be provided by one or more processing devices, such as general purpose and/or specialized processors. Memory 130 may comprise one or more volatile memory devices (for example, RAM chips), one or more non-volatile memory devices (for example, ROM or EEPROM chips), and/or one or more storage memory devices (for example, optical or magnetic disks).

Optical input device 160 may be for example, a scanner or a still image camera configured to acquire the light reflected by the objects situated within its field of view. In some embodiments, optical input device 160 may be external to computing device 100 and may be electronically coupled to computing device 100 via a wired or wireless connection.

Memory 130 may store instructions of editing application 190 for editing a text portion of an electronic document. Editing application 190 may be implemented as a function or tool to be invoked via a user interface of another application. Alternatively, editing application 190 may be implemented as a standalone application.

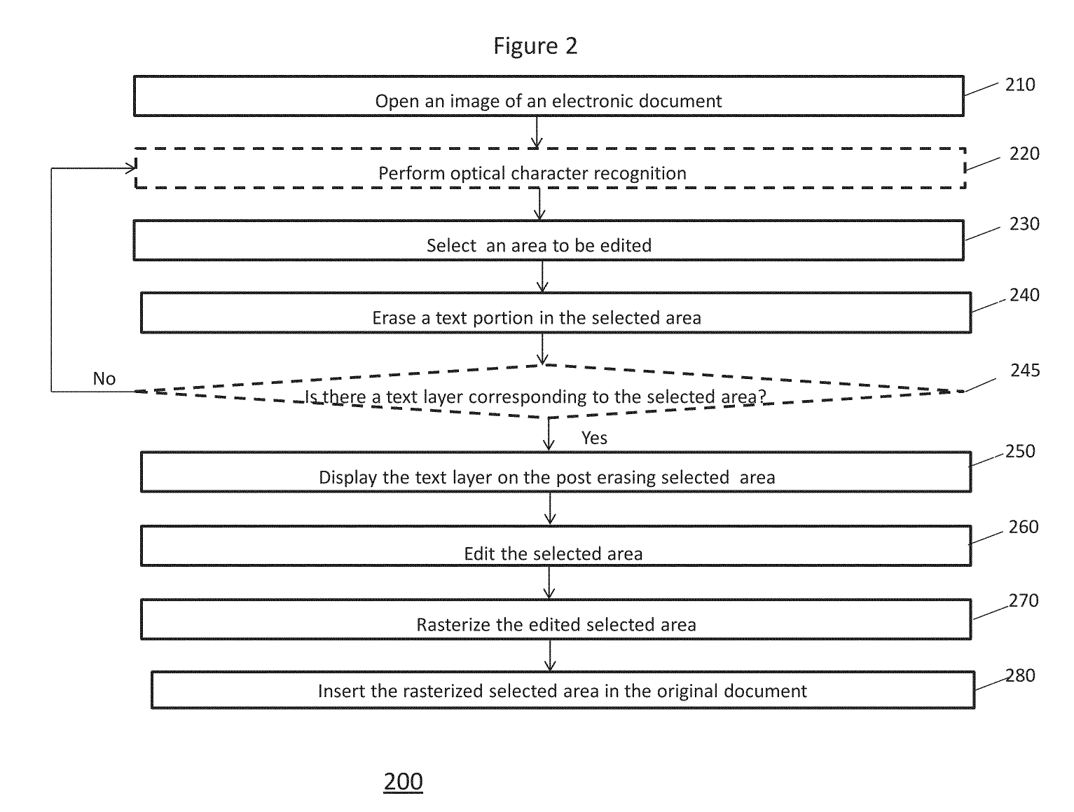

In an illustrative example, computing device 100 may acquire an electronic document (e.g., a document image). A user may open or create the electronic document using editing application 190. Computing device 100 may receive a selected area of the electronic document from the user or from default information stored in its memory. The selected area may have a number of shapes, including rectangle, circle, polygon. Computing device 100 may determine whether the selected area includes a text portion. As was mentioned, the text portion within the image may have a corresponding text layer. In other words, the editing application determines whether the selected area includes the text layer. The text layer may have existed originally, for example, as a hidden text layer of the document, or may have been produced by the OCR. Further details and operations of editing application 190 are described in conjunction with FIGS. 2-4.

FIG. 2 presents a flow-chart of one illustrative example of method 200 for editing an electronic document. The method and/or each of its individual functions, routines, subroutines, or operations may be performed by one or more processors of a computer system executing the method. In some embodiments, method 200 may be performed by a single processing thread. Alternatively, method 200 may be performed by two or more processing threads, each thread executing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processing threads implementing method 200 may be executed asynchronously with respect to each other. Therefore, while FIG. 2 and the associated description lists the operations of method 200 in certain order, various implementations of the method may perform at least some of the described operations in parallel and/or in arbitrary selected orders.

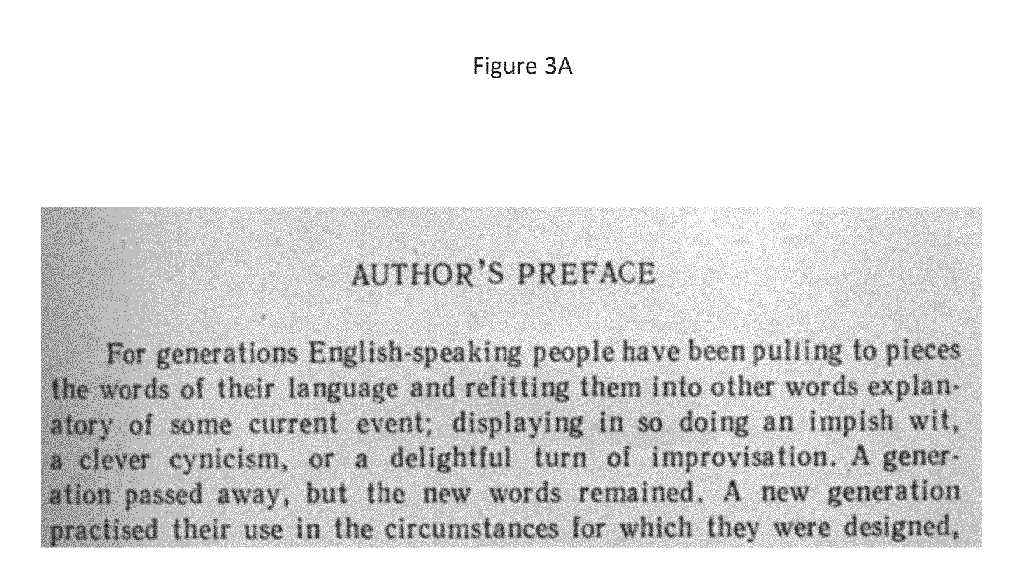

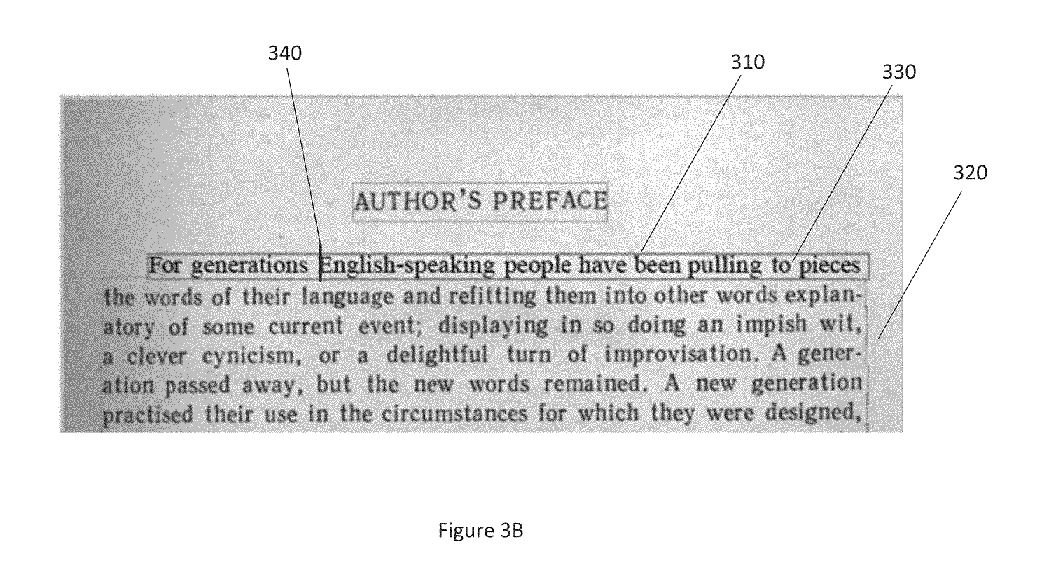

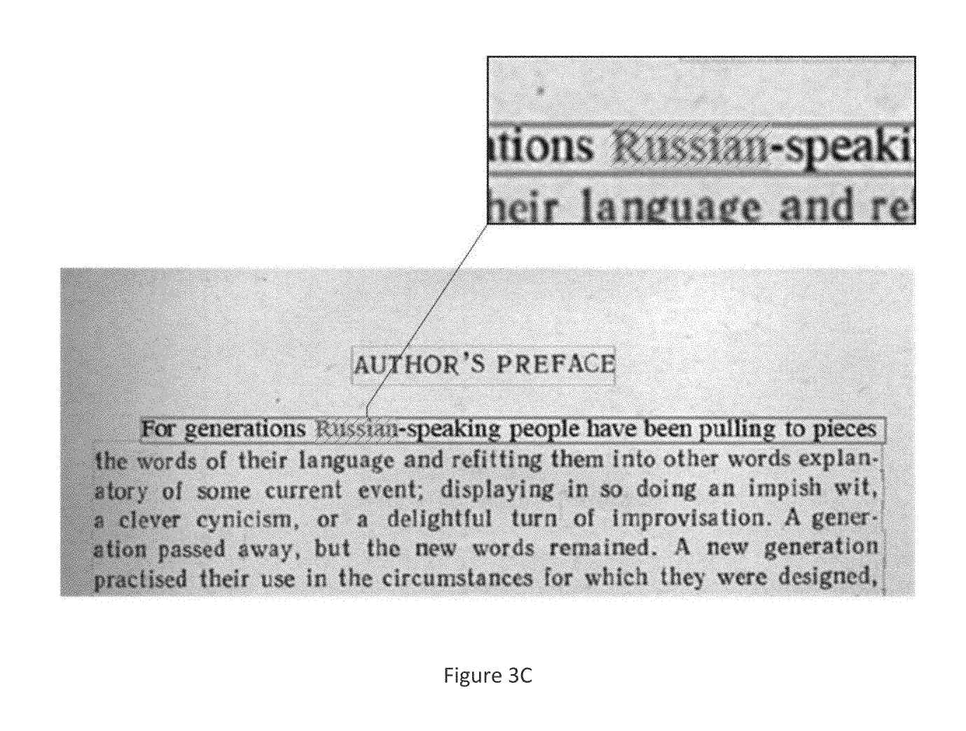

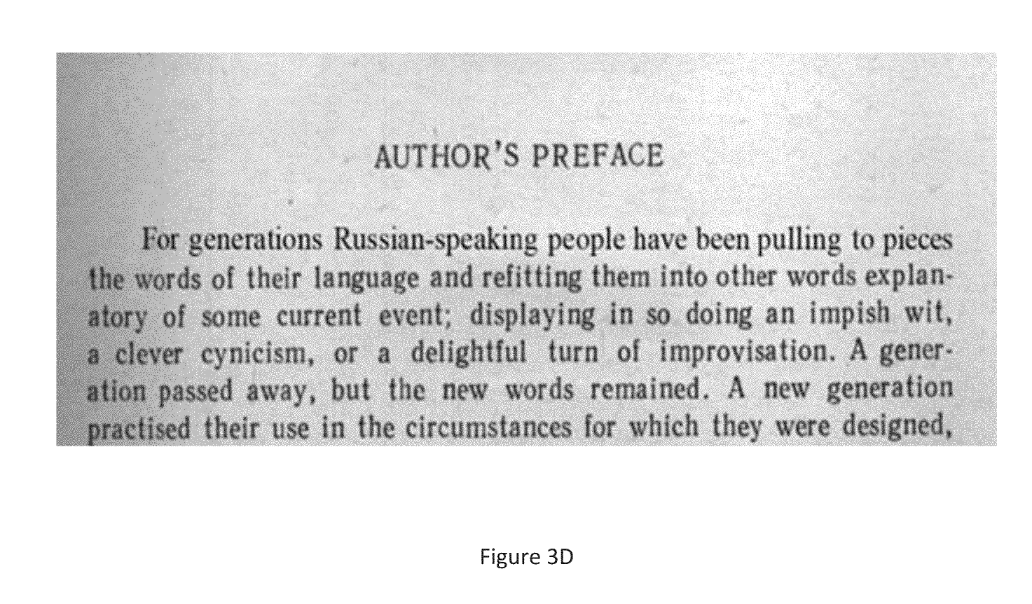

Step 210 may involve opening of an electronic document by a user. As the result, an image of the opened electronic document may be displayed to the user, for example, on a monitor or display of the computer system. For example, FIG. 3A shows an image of an opened electronic document, which may be, for example, a scan of the document, a photo of the document or a PDF of the document. An electronic document may contain a text portion and a background portion. Both text portion and background portion of the electronic document may be represented by their corresponding pixels.

In some embodiments, the method may involve optional step 220 of optical character recognition of the opened electronic document or one or more of its parts or areas, which may or may not be selected by the user. As the result of the optical character recognition, a corresponding text layer may be produced. In some embodiments, for a multipage document, a separate text layer may be produced for each recognized page of the document. Yet in some other embodiments, for a multipage document, a combined text layer may be produced for two or more pages of the document. In certain embodiments, such combined text layer may be produced for all pages of the document.

A text layer may contain a text layer metadata, which may contain information regarding position, e.g. coordinates of the text layer in the visual representation, i.e. image, of the electronic document. The text layer metadata may also contain information on whether the text layer is visible or transparent. Text layers of many electronic documents may be transparent and therefore, hidden/invisible for a user.

In some embodiments, a part or an area of the document, on which OCR is performed may be selected by a user. In certain embodiments, OCR may be run in the background, i.e. without interfering with the user's communication with the commuter system.

In some embodiments, an opened electronic document may already have a pre-existing text layer. In such a case, OCR may not be necessary and the available text layer may be used in further operations, such as step 250.

In some embodiments, the displayed electronic document may have one or more defects, such as a tilted angle, a distorted prospective, an excessive noise, a flare or a blur. In such a case, before performing OCR an image of the opened electronic document may be preprocessed to improve OCR quality. Preprocessing may involve, for example, one or more of the following: straightening the image, removing noise, flares and/or blurs from the image; correcting a distorted perspective in the image.

Although an image of the opened electronic document may be preprocessed to improve the quality of the image for optical character recognition, the image may be still displayed to the user in its original (pre-preprocessing) form, i.e. in the form which contains original defects of the image, which were corrected by the preprocessing. For example, when an image of the electronic document has a tilted angle, the image may be straightened/rotated to improve the quality of optical character recognition of the document, while the image is still displayed to the user for editing in its original tilted form. This option may allow producing a quality text layer, i.e. a text layer with less defects, via OCR, while letting the user to see the image in its original (pre-preprocessing) form when user performs the editing.

Step 230 may involve receiving by the computer system an information from the user or its memory regarding an area (a selected area) of the opened electronic document that the user wants to edit. The selected area may be a user selected area when selected by the user or a default selected area when the information regarding the selected area is received from the computer system's memory without the user's feedback. In some embodiments, if the document does not have a corresponding text layer, OCR may be performed to obtain a text layer, which corresponds to a text portion of the selected area. OCR also may be performed when the quality of a pre-existing text layer is not satisfactory. Verification of the quality of the pre-existing text layer may be involve, for example, performing automatic dictionary-based spell checking, spell-checking and/or automatic encoding validation of the pre-existing text layer.

If the selected area does not contain any text (does not contain a text portion), obtaining a text layer for the selected area may not be necessary.

Step 240 may involve removing the text portion from the selected area. One of the presently well-known common methods for erasing a text from an image is overlaying over the text to be erased a rectangle, which has a uniform color, for example, a white color. When such method is used, a boundary of the edited area, i.e. an area, where the text was erased, may be noticeable because the color of the edited area does not match background color(s) of portions of the document surrounding the edited area. As the result, the quality of the edited document may deteriorate compared to the original document. This may be particularly true when a document has a non-uniform background color. Thus, overlaying the text to be erased with a uniform color may be not acceptable.

Removing the text portion may be performed by affecting only text pixels, i.e. pixels which correspond to the text portion of the selected area, without affecting background pixels, i.e. pixels which correspond to the background portion of the selected area.

In some embodiments, removing the text portion may be performed by erasing the text pixels, without affecting the background pixels.

Yet in some embodiments, removing the text portion in step 240 may be performed using a “smart eraser” method, which is disclosed in U.S. Patent Application Publication No. 2016/0217117, which is incorporated herein by reference in its entirety. Such removing does not modify a background portion of the selected area, i.e. it does not delete background pixels of the selected area, which correspond to the background portion of that area. The “smart eraser” method affects only text pixels of the selected area, i.e. pixels, which correspond to a text portion of the selected area. In particular, the “smart eraser” method replaces the text pixels with blended/averaged background pixels of the background portion of the selected area using a certain mathematical averaging. After applying the “smart eraser” method, the selected area may contain only background pixels.

Step 240 may not be necessary when the selected area does not contain a text portion.

Step 245 may involve determining whether the selected area has a corresponding text layer. This step may be optional. In other words, if optical character recognition has not been performed for the whole document at step 220 right after the document was opened, then it may be assumed that optical character recognition is performed only for the selected area. In such case, the following sequence may be used: a) the user or the computer system identifies an area to be edited (“selected area”) in the opened document; b) optical character recognition is performed only for the selected area to obtain a text layer, which corresponds to the selected area (or in other words to a text portion of the selected area); c) removing the text portion without affecting the background portion (the background pixels).

At step 250 the selected area, without its text portion, may be displayed to the user as an editable area. For the selected area without an initial text portion, the editable area may include the unmodified background portion, while providing an option of adding a text. For the selected area, which initially contained a text portion, the editable area may also include its unmodified background portion. In addition, such editable area may include also the text representing the text layer (which corresponds to the text portion of the selected area) displayed as an editable text, i.e. a text, which may be edited (including modifying an existing text, deleting an existing text and adding a new text), highlighted and/or copied. The editable text representing the text layer may have the same font as the font of the text portion of the selected area. For the selected area, which initially contained a text portion, an editable area may be displayed after it is determined that the selected area has a corresponding text layer of acceptable quality and after removing the text portion of the selected area.

FIG. 3B shows the same document as FIG. 3A at editing stage, where selected area 310: “For generations English-speaking people have been pulling to pieces”, initial document 320, editable area within displayed for editing text layer 330, cursor 340 are marked.

The selected area may be displayed to the user as an editable area, which contains an editable text from a text layer, which corresponds to a text portion of the selected area. The background portion of the selected area remains unchanged. The editable text has the same font as the font of the text portion of the selected area. Thus, the disclosed method may allow text editing without changing the document's appearance, structure and/or content. In some embodiments, the whole document may be displayed to the user. Yet in some embodiments, only a part of the document may be displayed to the user so that the user could see the editable area better. For example, it may be possible to display to the user only the editable area without displaying other parts of the document.

The step of displaying the selected area as an editable area as discussed above may be novel. Alternative methods of image editing may allow editing an image of a document only after conversion of the image into an editable document format, such as MS Word. Such conversion may change one or more of appearance, structure and content of the document.

Another alternative method of editing a text in an image may be overlaying a rasterized image of a text block over the original image of the text. Such text block includes a text portion and a background portion. In this method, optical character recognition of the text in the original image is not performed. This means the overlaid text block may not have the same font as the text in the original image because the original image's text is not analyzed. This method may also mean that a user has to enter all the text of the text block manually. For example, if editing involves modifying only first and last words of a text block, the user will have to enter not only the first and the last words but also all the words in between.

Step 260 may involve editing (modifying) the editable text in the editable area. From the computer system's prospective, this step may involve receiving a feedback from the user, for example, via a graphic user interface, regarding modification(s) to be made in the editable text and executing these modification(s) to produce a modified text. The editable area with the modified text becomes a modified editable area. The background portion of the editable area remains unmodified. The modification(s) may or may not involve deleting one or more particular characters, such as a letter or a digit, or one or more character sequences, such as a word, or even an entire text portion; adding one or more particular characters, such as a letter or a digit, or one or more character sequences, such as a word; replacing one or more characters with one or more other characters; replacing one or more character sequences, such as a word, with one or more other character sequences. If the selected area did not contain a text portion, the modifications may involve adding a text portion to the selected area by adding one or more characters, such as a letter or a digit, or one or more character sequences, such as word.

FIG. 3C shows the same document as FIG. 3B, in which a modification has been performed in the editable area to produce a modified editable area. The modification is a replacement of the word “English” with the word “Russian.” As the result, the modified editable area reads as follows: “For generations Russian-speaking people have been pulling to pieces.” Editing in the present context may or may not involve deleting all the editable text.

After finishing the editing, the user may signal that the editing is completed. This can be accomplished, for example, by pointing/clicking on a part of the opened document, which is different from the selected area. From the computer system's prospective, this operation may correspond to receiving a feedback from the user that the editing is completed.

At step 270, the modified editable area may be rasterized to produce a rasterized modified area. Rasterizing, i.e. converting into pixels, involves both the modified (edited) text as well as the background portion.

As step 280, the rasterized modified area may be inserted in the original document (image of the document) by replacing the selected area of the original document. FIG. 3D shows a final edited electronic document.

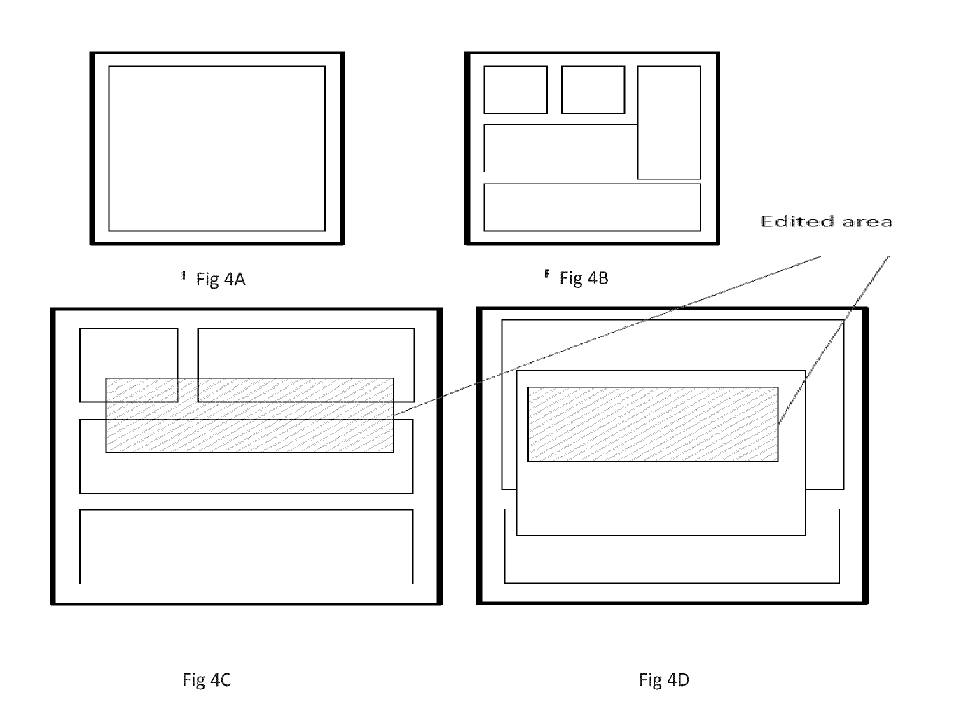

In some embodiments, the original electronic document may have only a single raster image, which may mean that the original electronic document is in a raster image format or that the original electronic document is in a compound image format, such as a PDF, which includes only a single raster image. FIG. 4A schematically illustrates a single raster image document. Insertion of the rasterized modified area in the single raster image original document may be relatively simple. The rasterized modified area may be inserted in such document based on coordinates of the selected area in the original document. Namely, each pixel of the selected area in the original document may be replaced with a corresponding pixel of the rasterized modified area.

In some embodiments, the original electronic document may be a compound file, such as a PDF file, which includes multiple, i.e. more than one, raster images. Positions of an individual raster image with respect to other raster image(s) of the document may vary. For example, an individual raster image may or may not overlap with other raster image(s) of the document. FIGS. 4B, 4C and 4D schematically illustrate some possible configurations of raster images in a compound file. In FIG. 4C, none of four raster images overlaps with any other raster image. In FIG. 4B, two of five raster images overlap with each other, while the remaining three raster images do not overlap with any other raster image. In FIG. 4D, one of three raster images overlaps with each of the other two raster images, which in turn do not overlap with each other.

Insertion of the rasterized modified area in the original multiple raster image document may be performed, for example, according one of the following approaches.

In some embodiments, the rasterized modified area may be inserted in the original multiple raster image document so that portion(s) of the rasterized modified area overlap with portions of several, i.e. more than one, raster images, which do not overlap with each other. For example, FIG. 4C illustrates a situation when a rasterized modified area (“edited area”) is inserted in a multiple raster image document so that its portions overlap with portions of three raster images, which do not overlap with each other. In such case, one embodiment, the insertion of the rasterized modified area in the original multiple raster image document may involve replacing each pixel in an overlapping portion of a raster image of the document (i.e. a portion of the raster image, which overlaps with the rasterized modified area) with a corresponding pixel of the rasterized modified area for each raster image, with which the rasterized modified area overlaps, based on coordinates of the selected area in the original document. In such case, a structure of a compound file, such as a PDF file, of the original multiple raster image document may be preserved in the final document. Yet in another embodiment, the insertion of the rasterized modified area in the original multiple raster image document may involve adding the rasterized modified area as an additional raster image over original raster images of the document according to coordinates of the selected area in the original document. In such case, a structure of a compound file, such as a PDF file, with the final edited document will differ from a structure of a compound file with the original document due to the addition of the additional raster image.

In some embodiments, the rasterized modified area may overlap with overlapping portions of two or more raster images of the original multiple raster image document. For example, FIG. 4D illustrates a situation when a rasterized modified area (“edited area”) is inserted in a multiple raster image document so that it overlaps with an overlapping portion of two overlapping raster images of the document. In such case, in one embodiment, the rasterized modified area may be inserted in the original multiple raster image document by replacing, in each raster image of the overlapping raster images of the document, each pixel in a portion of the raster image, which overlaps with the rasterized modified area, with a corresponding pixel of the rasterized modified area based on coordinates of the selected area. In such case, a structure of a compound file, such as a PDF file, of the original multiple raster image document may be preserved in the final document. In another embodiment, the insertion of the rasterized modified area in the original multiple raster image document may involve adding the rasterized modified area as an additional raster image over the overlapping portion of original overlapping raster images of the document according to coordinates of the selected area in the original document. In such case, a structure of a compound file, such as a PDF file, with the final edited document will differ from a structure of a compound file with the original document due to the addition of the additional raster image.

In some embodiments, multiple raster images of the original multiple raster image document may be converted into a single raster image to form a single raster image document. In such case, the rasterized modified area may be inserted into the converted single raster image document according to coordinates of the selected area in the original electronic document.

In some embodiments, an electronic document may be in a compound format, such as PDF, which may include one or more vector images in addition to one or more raster images. In such a case, for inserting the rasterized modified area in the document, each vector image may be converted into a raster image and then one the disclosed above insertion methods may be applied.

Inserting the rasterized modified area may produce an edited final document, which may have the same general appearance, including the background color and appearance, and the same text font as the original document.

In general, the disclosed methods are more suitable for making relatively small edits, so that a number of characters in the selected area of the original document does not differ significantly from a number of characters in the corresponding modified area of the final document.

If the number of characters in the selected area of the original document is significantly greater than the number of characters in the corresponding modified area of the final document, the final document may have contain too many blank spaces, which may change the general appearance of the final document compared to the original document.

If the number of characters in the selected area of the original document is significantly less than the number of characters in the corresponding modified area of the final document, the modified area may exceed the size of the selected area.

To avoid such situation, the selected area may be expanded.

In some embodiments, when the number of characters in the selected area of the original document is significantly greater than the number of characters in the corresponding modified area of the final document, it may be possible to extend the size of the selected area.

Yet in some embodiments, when the number of characters in the selected area of the original document is significantly less than the number of characters in the corresponding modified area of the final document, it may be possible to expand the selected area. For example, when an initially selected area is a line, an extended selected area may be a paragraph or a page.

In general, the disclosed methods may be applied for making greater edits. For example, in some embodiments, the whole document may be selected to become a selected area. Thus, particular steps of the method, removing a text portion, displaying an editable area and rasterizing a modified (edited) area, may be applied to the whole document. Although such application of the disclosed method is possible, a final edited document in such a case may have an appearance significantly different from the original document.

FIG. 5 illustrates a more detailed diagram of an example computing device 500 within which a set of instructions, for causing the computing device to perform any one or more of the methods discussed herein, may be executed. The computing device 500 may include the same components as computing device 100 of FIG. 1, as well as some additional or different components, some of which may be optional and not necessary to provide aspects of the present disclosure. The computing device may be connected to other computing device in a LAN, an intranet, an extranet, or the Internet. The computing device may operate in the capacity of a server or a client computing device in client-server network environment, or as a peer computing device in a peer-to-peer (or distributed) network environment. The computing device may be a provided by a personal computer (PC), a tablet PC, a set-top box (STB), a Personal Digital Assistant (PDA), a cellular telephone, or any computing device capable of executing a set of instructions (sequential or otherwise) that specify operations to be performed by that computing device. Further, while only a single computing device is illustrated, the term “computing device” shall also be taken to include any collection of computing devices that individually or jointly execute a set (or multiple sets) of instructions to perform any one or more of the methodologies discussed herein.

Exemplary computing device 500 includes a processor 502, a main memory 504 (e.g., read-only memory (ROM) or dynamic random access memory (DRAM)), and a data storage device 516, which communicate with each other via a bus 508.

Processor 502 may be represented by one or more general-purpose processing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute instructions 526 for performing the operations and functions discussed herein.

Computing device 500 may further include a network interface device 522, a display device 510, an character input device 512 (e.g., a keyboard), a touch screen input device and a cursor control device 514.

Data storage device 516 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computing device 500, main memory 504 and processor 502 also constituting computer-readable storage media. Instructions 526 may further be transmitted or received over network 518 via network interface device 522.

In certain implementations, instructions 526 may include instructions of method 400 for selectively erasing portions of an electronic document, and may be performed by application 190 of FIG. 1. While computer-readable storage medium 524 is shown in the example of FIG. 5 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A text editing method comprising:
receiving a selected pixel area of an original electronic document comprising an original background portion;
displaying to a user an editable area, which corresponds to the selected area, without modifying the background portion;
receiving a feedback from the user regarding a textual modification to be made in the editable area and executing the modification to produce a modified editable text, so that the editable area with the modified editable text becomes a modified editable area, wherein the background portion remains unmodified;
rasterizing the modified editable area to produce a rasterized modified area comprising a) a modified text portion and b) a background portion, which is unmodified compared to the background portion of the selected pixel area; and
inserting the rasterized modified area into the electronic document to produce a modified electronic document.

2. The method of claim 1, wherein the selected pixel area is received from the user via a graphical user interface.

3. The method of claim 1, wherein the original electronic document further comprises an original text portion and the method further comprises determining whether the original text portion has a corresponding quality text layer; and removing the text portion without modifying the background portion; wherein the editable area displayed to the user corresponds to the selected area after said removing, the editable area contains the text layer displayed as an editable text and the modified text portion is modified compared to the original text portion.

4. The method of claim 3, wherein said modification does not involve deleting all of the editable text.

5. The method of claim 3, wherein the original electronic document comprises a pre-existing text layer.

6. The method of claim 5, wherein said determining comprises determining whether the pre-existing text layer is a quality text layer.

7. The method of claim 3, further comprising obtaining the text layer by performing optical character recognition of at least the selected area of the original electronic document.

8. The method of claim 7, further preprocessing an image of the document to improve a quality of the optical character recognition, wherein said preprocessing comprises one or more of straightening the image; removing a noise, flares and/or blurs from the image; and correcting a distorted perspective in the image.

9. The method of claim 3, wherein said removing the text portion comprises erasing pixels of the text portion.

10. The method of claim 3, wherein said removing comprises coloring a text pixel of the text portion based a color of one or more background pixels of the background portion that are adjacent to said text pixel.

11. The method of claim 1, wherein the selected area does not include a text portion and wherein said receiving the feedback from the user regarding the textual modification to be made in the editable area comprises receiving a feedback from the user regarding a text to be added to the editable area.

12. The method of claim 1, wherein the original electronic document is a single raster image document.

13. The method of claim 12, wherein said inserting comprises replacing each pixel of the selected area with a corresponding pixel of the rasterized modified area.

14. The method of claim 1, wherein the original electronic document is a multiple raster image electronic document.

15. The method of claim 14, wherein said inserting comprises converting the multiple raster image electronic document into a single raster image electronic document and inserting the rasterized modified area into the single raster image electronic document.

16. The method of claim 15, wherein said inserting comprises adding the rasterized modified area as an additional raster image to the single raster image of the single raster image electronic document so that the additional raster image overlaps the single raster image.

17. The method of claim 14, wherein the rasterized modified area overlaps with portions of two or more non-overlapping raster images of the multiple raster image electronic document.

18. The method of claim 17, wherein said inserting comprises, for each raster image of the two or more raster images, replacing each pixel of a portion of the raster image, which overlaps with the rasterized modified area, with a corresponding pixel of the rasterized modified area.

19. The method of claim 17, wherein said inserting comprises adding the rasterized modified area as an additional raster image over the raster images of the multiple raster image electronic document.

20. The method of claim 14, wherein the rasterized modified area overlaps with overlapping portions of two or more overlapping raster images of the multiple raster image electronic document.

21. The method of claim 20, wherein said inserting comprises, for each raster image of the two or more overlapping images, replacing each pixel in a portion of the raster image, which overlaps with the rasterized modified area, with a corresponding pixel of the rasterized modified area.

22. The method of claim 20, wherein said inserting comprises adding the rasterized modified area as an additional raster image over the raster images of the multiple raster image electronic document.

23. A computer system comprising:
a memory; and
a processor operatively coupled to the memory, the processor is configured to:
receive a selected pixel area of an original electronic document comprising an original background portion;
display to a user an editable area, which corresponds to the selected area, without modifying the background portion;
receive a feedback from the user regarding a textual modification to be made in the editable area and execute the modification to produce a modified editable text, so that the editable area with the modified editable text becomes a modified editable area, wherein the background portion remains unmodified;
rasterize the modified editable area to produce a rasterized modified area comprising a) a modified text portion and b) a background portion, which is unmodified compared to the background portion of the selected pixel area; and
insert the rasterized modified area into the electronic document to produce a modified electronic document.

24. The computer system of claim 23, wherein the original electronic document further comprises an original text portion and the processor is further configured to determine whether the original text portion has a corresponding quality text layer; and to remove the text portion without modifying the background portion; wherein the editable area displayed to the user corresponds to the selected area after the text portion was removed, the editable area contains the text layer displayed as an editable text and the modified text portion is modified compared to the original text portion.

25. A non-transitory computer readable storage medium comprising instructions that, when executed by a processor, cause the processor to perform operations comprising:
receiving a selected pixel area of an original electronic document comprising an original background portion;
displaying to a user an editable area, which corresponds to the selected area, without modifying the background portion;
receiving a feedback from the user regarding a textual modification to be made in the editable area and executing the modification to produce a modified editable text, so that the editable area with the modified editable text becomes a modified editable area, wherein the background portion remains unmodified;
rasterizing the modified editable area to produce a rasterized modified area comprising a) a modified text portion and b) a background portion, which is unmodified compared to the background portion of the selected pixel area; and
inserting the rasterized modified area into the electronic document to produce a modified electronic document.

26. The medium of claim 24, wherein the original electronic document further comprises an original text portion and the operations further comprise determining whether the original text portion has a corresponding quality text layer and removing the text portion, without modifying the background portion; wherein the editable area displayed to the user corresponds to the selected area after said removing, the editable area contains the text layer displayed as an editable text and the modified text portion is modified compared to the original text portion.
